(19) United States
(12) Patent Application Publication
(10) Pub. No.: US 2026/0181479 A1
(43) Pub. Date: Jun. 25, 2026

(54) Dynamic Allocation of Leftover Bandwidth in Satellite Communication Network

(71) Applicant: Hughes Network Systems, LLC, Germantown, MD (US)

(72) Inventors: Aniket PUGAONKAR, Rockville, MD (US); Edward BEAL, Germantown, MD (US); Venkatasubramaniam GANESAN, Germantown, MD (US); Yeqing TANG, North Potomac, MD (US)

(73) Assignee: Hughes Network Systems, LLC, Germantown, MD (US)

(21) Appl. No.: 19/098,977

(22) Filed: Apr. 2, 2025

Related U.S. Application Data
(60) Provisional application No. 63/738,257, filed on Dec. 23, 2024.

(51) Int. Cl. H04W 28/08; H04B 7/185; H04W 28/20

(52) U.S. Cl. CPC H04W 28/0942; H04B 7/18539; H04W 28/20

(57) ABSTRACT

A method and system for distributing leftover bandwidth in a satellite communication network is provided. The method involves monitoring utilization rates of real-time leftover bandwidth allocations for terminals, calculating leftover bandwidth allocations based on these rates, and adjusting them with a scale that prioritizes allocations based on advertised demand. The system includes a bandwidth allocator configured to perform these tasks and a receiver to handle bursts transmitted within the allocated bandwidth. The method and system aim to optimize bandwidth distribution by considering factors such as anticipated demand, traffic priorities, and historical utilization rates.

### CROSS-REFERENCE TO RELATED APPLICATIONS AND INCORPORATION BY REFERENCE

The present application claims the benefit under 35 U.S.C. 119(e) of U.S. Provisional Application Ser. No. 63/738,257 filed Dec. 23, 2024, which is incorporated herein by reference in its entirety.

### FIELD

The present teachings enhance utilization of leftover bandwidth in satellite networks with dynamic allocation of leftover bandwidth to heavy traffic terminals in contrast to light traffic terminals.

### BACKGROUND

Efficient utilization of the finite radio frequency spectrum in satellite communication networks is essential. These networks are essential for a wide range of applications, including voice communication, internet access, broadcasting, and emergency services. However, managing bandwidth in satellite networks presents unique challenges due to the limited spectrum available and the need to accommodate varying demand patterns from different users and applications.

Satellite networks typically employ TDMA (Time Division Multiple Access) shared-channel access to allocate bandwidth to terminals sharing the channel. The bandwidth allocation ensures synchronized transmissions to avoid interference and collisions. The present teachings use unallocated or leftover bandwidth in satellite networks to enhance the Quality of Service (QoS) for various user traffic types. Typically, the available bandwidth is managed by a bandwidth allocator at a ground station. User terminals transmit data in allocated time slots, which data is processed and forwarded by the ground station. QoS is crucial, ensuring different types of traffic—such as VoIP, online gaming, internet browsing, video conferencing, and video streaming—receive appropriate service levels.

The prior art leftover bandwidth allocation algorithm utilizes available bandwidth by evenly distributing any unused bandwidth across user terminals. However, this approach can lead to several issues including inefficient utilization, thrashing and low throughput. In inefficient utilization, some terminals do not utilize the leftover bandwidth, even though the unused bandwidth is still accounted for in a VNO's (Virtual Network Operator's) overall subscription limit. In thrashing, excessive leftover bandwidth distribution by the bandwidth allocator can lead to throttled VNOs and fluctuating throughput. In low throughput, the bandwidth allocator completely stops leftover bandwidth distribution resulting in low throughput for certain applications due to the high RTT (Round Trip Time) in satellite communications.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In some aspects, the techniques described herein relate to a method for distributing leftover bandwidth in a satellite communication network, the method including: monitoring, with a bandwidth allocator, utilization rates of real-time leftover bandwidth allocations for terminals; calculating, for the terminals, leftover bandwidth allocations based on a respective utilization rate of the utilization rates; adjusting the leftover bandwidth allocations for the terminals with a scale that prioritizes a respective leftover bandwidth allocation for a respective terminal based on a respective advertised demand; allocating, with the bandwidth allocator, the leftover bandwidth allocations to the terminals; and receiving one or more bursts transmitted from the terminals within one of the leftover bandwidth allocations.

In some aspects, the techniques described herein relate to a method, wherein the adjusting further scales based on an anticipated demand for the respective terminal.

In some aspects, the techniques described herein relate to a method, wherein the anticipated demand includes a predicted demand anticipated to be advertised in a next 100 or less frames.

In some aspects, the techniques described herein relate to a method, wherein the utilization rates further include a respective historical utilization rate of the leftover bandwidth allocations.

In some aspects, the techniques described herein relate to a method, wherein the calculating includes calculating the utilization rates for traffic priorities, wherein the traffic priorities include a real-time type, a continuous type, and a non-critical traffic type.

In some aspects, the techniques described herein relate to a method, wherein the monitoring maintains a record over a number of frames of the leftover bandwidth allocations provided to the terminals and a corresponding utilization by the terminals.

In some aspects, the techniques described herein relate to a method, further including adding a boost value to the respective leftover bandwidth allocation to respond to a spike in the respective advertised demand.

In some aspects, the techniques described herein relate to a method, further including adding a boost value to the respective leftover bandwidth allocation beyond the respective advertised demand, when one of the terminals is requesting bandwidth for an application including an in-network adaptability feature.

In some aspects, the techniques described herein relate to a method, wherein the application includes at least one of a live video streaming application or a video conferencing application (such as, a Zoom video meeting or a Microsoft Teams video meeting).

In some aspects, the techniques described herein relate to a method, further including adapting a leftover allocation threshold based on learning from a pattern of the respective utilization rate.

In some aspects, the techniques described herein relate to a method, wherein the learning is based on at least one of a simulation result or an input threshold configuration.

In some aspects, the techniques described herein relate to a method, wherein the adjusting alters the scale based on a respective anticipated demand for one of the terminals.

In some aspects, the techniques described herein relate to a method, wherein the adjusting does not eliminate the respective leftover bandwidth allocation for one of the terminals when explicitly requested even when the respective advertised demand for one of the terminals is less than a threshold.

In some aspects, the techniques described herein relate to a system to distribute leftover bandwidth in a satellite communication network, the system including: a bandwidth allocator configured to: monitor utilization rates of real-time leftover bandwidth allocations for terminals, calculate, for the terminals, leftover bandwidth allocations based on a respective utilization rate of the utilization rates, adjust the leftover bandwidth allocations for the terminals with a scale that prioritizes a respective leftover bandwidth allocation for a respective terminal based on a respective advertised demand, and allocate the leftover bandwidth allocations to the terminals; and a receiver to receive one or more bursts transmitted from the terminals within one of the leftover bandwidth allocations.

In some aspects, the techniques described herein relate to a system, wherein the adjusting further scales based on an anticipated demand for the respective terminal.

In some aspects, the techniques described herein relate to a system, wherein the bandwidth allocator is further configured to calculate the utilization rates for traffic priorities, wherein the traffic priorities include a real-time type, a continuous type, and a non-critical traffic type.

In some aspects, the techniques described herein relate to a system, wherein the bandwidth allocator is further configured to maintain a record over a number of frames of the leftover bandwidth allocations provided to the terminals and a corresponding utilization by the terminals.

In some aspects, the techniques described herein relate to a system, wherein the bandwidth allocator is further configured to add a boost value to the respective leftover bandwidth allocation to respond to a spike in the respective advertised demand.

In some aspects, the techniques described herein relate to a system, wherein the bandwidth allocator is further configured to add a boost value to the respective leftover bandwidth allocation beyond the respective advertised demand, when one of the terminals is requesting bandwidth for an application including an in-network adaptability feature.

In some aspects, the techniques described herein relate to a system, wherein the bandwidth allocator is further configured to adapt a leftover allocation threshold based on learning from a pattern of the respective utilization rate.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates a satellite communication system, according to various embodiments.

FIG. 2 is a flowchart of an example method for distributing leftover bandwidth in a satellite communication network.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

### Introduction

The present teachings may be extended to communication networks utilizing gateway hardware and software elements for data transportation. For instance, it could be integrated into satellite communication systems or broadband services operating within communication networks employing gateway hardware and software elements similar to a satellite communications network.

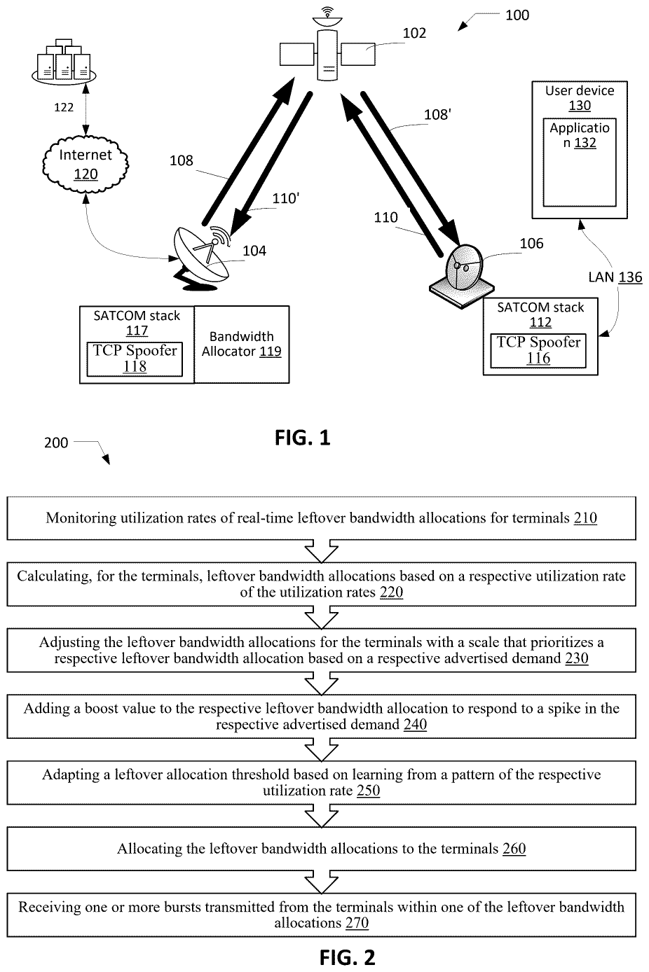

FIG. 1 illustrates a satellite communication system, according to various embodiments.

A satellite system 100 uses Time Division Multiple Access (TDMA) on a frequency channel between a gateway 104 and terminal 106. TDMA is a digital modulation technique that allows a terminal population to share the same frequency channel by dividing the signal into different timeslots that may be further divided into symbols and bits using a bandwidth allocator 119.

Communication from the gateway 104 to the terminal 106 is via an outroute that includes an uplink 108 from the gateway 104 to satellite 102. Satellite 102 relays communications as a downlink 108′ to the terminal 106. Communication from the terminal 106 to the gateway 104 is via an inroute that includes an uplink 110 from the terminal 106 relayed by the satellite 102 as a downlink 110′ to the gateway 104. Gateway 104 may be terrestrially connected to internet 120 where a server 122 resides.

The terminal 106 may be connected to a user device 130 via LAN 136. Terminal 106 includes a SATCOM stack 112 including a TCP spoofer 116. Gateway 104 includes bandwidth allocator 119 and a SATCOM stack 117 including a TCP spoofer 118. The SATCOM stack 112 requests bandwidth from bandwidth allocator 119 for the inroute; bandwidth allocator 119 allocates bandwidth on an outroute also.

User device 130 may host an application 132. User device 130 connects to server 122 via the LAN 136 to the terminal 106 to the satellite 102 to the gateway 104 to internet 120. TCP spoofer 116 and TCP spoofer 118 jointly improve performance for application 132 on user device 130. With the TCP spoofer 116, the terminal 106 simulates (“spoofs”) a remote endpoint of a connection to user device 130, while using a satellite protocol (via SATCOM stack 112 and SATCOM stack 117) to communicate with gateway 104 that performs the equivalent spoof at the other end (via TCP spoofer 118 to server 122) of the satellite link (either the inroute or outroute).

In satellite system 100, the radio frequency spectrum is a highly limited resource and TDMA is used as a primary channel access method. In TDMA, the available bandwidth is divided into timeslots, which are allocated to specific terminals (transmitters) and managed by a bandwidth allocator 119 at gateway 104 (receiver). This synchronization of transmitters ensures that each terminal transmits during its assigned time slot, preventing interference and collisions.

Data from various user terminals is transmitted in bursts according to their allocated time slots. The gateway processes (demodulates, decodes) this data and forwards it through the internet. Ensuring Quality of Service (QoS) in satellite communication is essential to meet the distinct service requirements of different types of traffic, such as VoIP, online gaming, internet browsing, video conferencing, video streaming, and file uploads/downloads. These services are typically categorized into four main traffic types—conversational, interactive, streaming, and bulk—each with specific QoS requirements, including latency, jitter, priority, and reserved bandwidth.

The bandwidth allocator 119 assigns bandwidth based on the demand from various user terminals operating within a frequency channel. Several user needs are balanced during bandwidth distribution. For instance, VoIP and real-time calls require reserved bandwidth with low jitter and may involve admission control, where requests can be denied if sufficient bandwidth is unavailable. As such, the bandwidth allocator allocates bandwidth in bursts at specific times for active user terminals for VoIP and real-time calls.

Allocation of bandwidth on an inroute may be based on allocation requests including an advertised demand sent by the terminal 106 to bandwidth allocator 119, for example, via the SATCOM stack 112. In some embodiments, allocation requests from terminal 106 to bandwidth allocator 119 include an anticipated demand on the inroute. In some embodiments, bandwidth allocator 119 determines an anticipated demand, on an inroute or an outroute, based on Deep Packet Inspection (DPI), examination of an upper layer connection type or the like. In some embodiments, DPI may be performed on gateway 104 and information gleaned about a connection may be sent to a corresponding terminal from gateway 104. Allocation Protocols supported by SATCOM stack 112 may include TCP/IP, a proprietary satellite protocol, or the like.

### Leftover Bandwidth

In the prior art, at the end of each allocation cycle, any remaining or unused bandwidth, referred to as “leftover” bandwidth, is distributed evenly among the user terminals until all bandwidth for that time duration is fully utilized. However, this approach to utilizing leftover bandwidth can present challenges. While the prior art maximizes bandwidth usage by redistributing unused bandwidth, some terminals do not utilize this bandwidth effectively. Despite being unused, this bandwidth is still counted against the overall subscription limit of the Virtual Network Operator (VNO). In some cases, this can lead to thrashing—where excessive leftover bandwidth allocation results in VNO throttling and the bandwidth allocator halts further leftover distributions, causing erratic throughput.

Conversely, eliminating leftover bandwidth distribution entirely to resolve this issue—by allocating bandwidth strictly according to demand—can result in reduced throughput for certain applications. Due to the large Round Trip Time (RTT) in satellite communication, addressing sudden backlog demands from terminals takes at least one RTT. As a result, some leftover bandwidth remains necessary to meet immediate bandwidth needs.

The present teachings distribute leftover bandwidth and prioritize terminals with higher demand and providing additional bandwidth for an anticipated demand that is imminent. Imminent demand includes demand anticipated in the next few frames, for example, 20 frames or less, 50 frames or less, 100 frames or less, or the like. The effectiveness of leftover bandwidth allocation in satellite communication networks is improved by prioritizing terminals with higher immediate needs and optimizing the distribution based on real-time advertised and anticipated demand. Responding dynamically to traffic spikes by targeted boosts to high-demand terminals based on tracking utilization patterns ensures more efficient use of the available spectrum and enhances the QoS for applications.

Bandwidth allocator 119 may dynamically adjust the leftover bandwidth allocation—scaling it up or down based on the terminal's recent utilization patterns and current demand. The distribution of leftover bandwidth may be based on or provide for one or more of the following:
Initial Bandwidth Boost: Providing an initial boost to terminals with recently activated large backlog demands to enhance throughput for applications with flow control mechanisms, such as live video streaming, by providing extra allocation during the initial probing phase.
Utilization Tracking: Track leftover bandwidth utilization to identify heavy traffic terminals and favor terminals utilizing the leftover bandwidth during allocation.
Priority-based Allocation: Calculate per-priority usage to identify where the leftover bandwidth is most needed.
Minimal Allocation for Lightly Loaded Terminals: Minimize or eliminate leftover allocation for lightly loaded terminals unless explicitly requested.
Sudden Traffic Increase Management: Allocate additional leftover bandwidth based on abrupt large demand spikes.

### Initial Bandwidth Boost for High Backlog Terminals

An initial bandwidth boost may be provided to terminals that have just become active with a large backlog demand (the just become active refers to a large backlog demand becoming active, not to a terminal just becoming active). Variable leftover bandwidth thresholds may be configured for a terminal based on its reported backlog. Initially, the threshold configurations may be based on simulation results or otherwise input. In some embodiments, bandwidth allocator 119 includes a learning algorithm to monitor and to adjust the threshold values dynamically based on real-time utilization patterns may be provided.

The bandwidth boost enables TCP spoofer in the terminal (transmitter) to open a larger TCP window, facilitating the flow of more Layer 3 (L3) traffic, thereby improving throughput and reducing latency.

### Tracking and Scaling Leftover Utilization

The utilization of leftover bandwidth by terminals may be monitored to identify terminals with heavy traffic as potential targets for additional allocation. The monitoring may continuously track the amount of leftover bandwidth utilized by each terminal. In some embodiments, bandwidth allocator 119 maintains a record of bandwidth allocations provided to terminals over a configurable number of frames, along with a corresponding utilization by those terminals. For terminals exhibiting high traffic, the bandwidth allocator 119 may dynamically adjust the leftover bandwidth allocation—scaling it up or down based on a terminal's recent utilization patterns, current or advertised demand, and anticipated demand.

### Priority-based Bandwidth Allocation

Bandwidth allocator 119 may calculate usage based on traffic priority (interactive, streaming, bulk) to ensure that leftover bandwidth is allocated effectively. Bandwidth allocator 119 may analyze the priority of traffic types where leftover bandwidth is being utilized by the terminal. To analyze the leftover bandwidth usage, the calculating may be performed for each active terminal over a configurable number of frames, categorized by priority. In some embodiments, additional bandwidth may be allocated based on a terminal's advertised demand or anticipated demand for each priority category, ensuring that higher-priority traffic receives the necessary resources.

### Minimal Allocation for Lightly Loaded Terminals

Bandwidth allocator 119 may minimize or eliminate leftover bandwidth allocation for lightly loaded terminals unless explicitly requested. For terminals with low traffic demand, allocating of leftover bandwidth may be reduced or avoided unless the terminal specifically requests it. When requested, leftover usage may be tracked and allocated as described above.

### Responsive Allocation for Sudden Traffic Increases

Bandwidth allocator 119 may respond to sudden traffic spikes by allocating additional leftover bandwidth based on a terminal's backlog. When a terminal experiences an abrupt and significant increase in bandwidth demand, bandwidth allocator 119 may assess how much additional leftover bandwidth can be allocated to meet this demand. Leftover demand allocation for sudden traffic increases may mirror the handling for initial bandwidth boost by the bandwidth allocator 119.

### Support for Flow-Controlled Applications

Bandwidth allocator 119 may enhance the performance of applications that implement flow control mechanisms, for example, live video streaming or video conferencing streaming (such as, Zoom and Microsoft Teams video meetings). These applications probe a network's link capacity and ramp up gradually to a desired throughput. To implement flow control, these applications start with a low throughput and require additional bandwidth beyond the advertised backlog to reach optimal throughput. The prior art backlog-based allocation algorithm does not work well for these kinds of applications.

To alleviate this issue, terminal 106 may inform bandwidth allocator 119 about these connections in their backlog request. Terminal 106 may learn about a connection's upper layer application type through static classifier rules. In some embodiments, a DPI at gateway 104 may determine a connection's upper layer application type and convey the connection type to bandwidth allocator 119 directly or via terminal 106. Sandvine is an exemplary DPI. Bandwidth allocator 119 may allocate additional leftover bandwidth during the probing phase of these applications to help them quickly reach desired throughput to improve application performance.

### Operation of Leftover Bandwidth Distribution

FIG. 2 is a flowchart of an example method for distributing leftover bandwidth in a satellite communication network.

A method 200 for distributing leftover bandwidth in a satellite communication network may provide real-time leftover bandwidth allocations for terminals. Method 200 may ensure that the distribution of leftover bandwidth is optimized to prioritize terminals with higher demand, thereby enhancing the efficiency of bandwidth allocation in the satellite communication network. Method 200 optimizes the bandwidth allocation by ensuring that no bandwidth is wasted and that the terminals can transmit their data efficiently.

Method 200 includes operation 210 for monitoring, with a bandwidth allocator, utilization rates of real-time leftover bandwidth allocations for terminals. Operation 210 may involve maintaining a record over a number of frames of the leftover bandwidth allocations provided to the terminals and a corresponding utilization by the terminals. Operation 210 may track utilization patterns to identify terminals with heavy traffic as potential targets for additional allocation. Operation 210 may be configured to dynamically adjust threshold values based on real-time utilization patterns, which may be informed by simulation results or input threshold configurations. Operation 210 may configure variable leftover bandwidth thresholds to optimize bandwidth allocation based on terminal backlog and real-time utilization.

Method 200 includes operation 220 for calculating, for the terminals, leftover bandwidth allocations based on a respective utilization rate of the utilization rates. Operation 220 may involve calculating the leftover bandwidth allocations for terminals based on their respective utilization rates. This calculation may consider various traffic priorities, which can include real-time, continuous, and other traffic types. The bandwidth allocator may be responsible for this calculation, potentially optimizing the allocation of leftover bandwidth by prioritizing terminals with higher demand. The calculation may be influenced by the traffic priority, which may include interactive, bulk, and streaming traffic. Operation 220 may analyze the utilization rates to determine how much leftover bandwidth should be allocated to each terminal, ensuring that the allocation is effective and meets the demands of different traffic types.

Operation 220 may consider historical utilization rates, which may provide insights into the patterns of bandwidth usage by the terminals. By understanding these patterns, the bandwidth allocator may dynamically adjust the allocations to optimize the use of available bandwidth. Operation 220 may track utilization patterns to identify terminals with heavy traffic as potential targets for additional allocation. This dynamic approach may ensure that the leftover bandwidth is distributed efficiently, enhancing the quality of service for various applications within the satellite communication network.

Method 200 includes operation 230 for adjusting the leftover bandwidth allocations for the terminals with a scale that prioritizes a respective leftover bandwidth allocation for a respective terminal based on a respective advertised demand. This adjustment may be further refined by scaling based on an anticipated demand for the respective terminal, which may include a predicted demand anticipated to be advertised in the next set of frames, for example, 100 or fewer frames. The utilization rates may incorporate a respective historical utilization rate of the leftover bandwidth allocations, allowing for a more informed adjustment. The adjustment may alter the scale based on a respective anticipated demand for one of the terminals, ensuring that the allocation does not eliminate the respective leftover bandwidth allocation for one of the terminals when explicitly requested, even if the respective advertised demand for one of the terminals is less than a threshold. This comprehensive approach to adjusting leftover bandwidth allocations may ensure that terminals with higher demand are prioritized, and additional bandwidth is provided for anticipated demand, thereby optimizing the distribution of leftover bandwidth in a satellite communication network.

Method 200 includes operation 240 for adding a boost value to the respective leftover bandwidth allocation to respond to a spike in the respective advertised demand. The boost value may be added to the respective leftover bandwidth allocation to respond to a spike in the respective advertised demand. This boost may extend beyond the respective advertised demand when one of the terminals requests bandwidth for an application including an in-network adaptability feature, such as live video streaming, Zoom video meetings, or Microsoft Teams video meetings.

Method 200 includes operation 250 for adapting a leftover allocation threshold based on learning from a pattern of the respective utilization rate. The adapting may be informed by simulation results or an input threshold configuration.

Method 200 includes operation 260 for allocating, with the bandwidth allocator, the leftover bandwidth allocations to the terminals. In the context of the allocation of leftover bandwidth to terminals, method 299 may distribute available bandwidth that remains after initial allocations to terminals have been made, ensuring that terminals with varying demands receive appropriate bandwidth resources potentially prioritizing terminals based on their immediate and anticipated demands.

Method 200 includes operation 270 for receiving one or more bursts transmitted from the terminals within one of the leftover bandwidth allocations. Operation 270 informs that the distributed leftover bandwidth is effectively utilized by the terminals. The bursts, which may represent data packets or signals, can be received by a receiver, potentially indicating the successful transmission of data within the leftover bandwidth allocation. The reception of bursts may also serve as a feedback mechanism to assess the effectiveness of the bandwidth allocation strategy and to make necessary adjustments for future allocations, for example, the learning of operation 250.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for distributing leftover bandwidth in a satellite communication network, the method comprising:
monitoring, with a bandwidth allocator, utilization rates of real-time leftover bandwidth allocations for terminals;
calculating, for the terminals, leftover bandwidth allocations based on a respective utilization rate of the utilization rates;
adjusting the leftover bandwidth allocations for the terminals with a scale that prioritizes a respective leftover bandwidth allocation for a respective terminal based on a respective advertised demand;
allocating, with the bandwidth allocator, the leftover bandwidth allocations to the terminals; and
receiving one or more bursts transmitted from the terminals within one of the leftover bandwidth allocations.

2. The method of claim 1, wherein the adjusting further scales based on an anticipated demand for the respective terminal.

3. The method of claim 2, wherein the anticipated demand comprises a predicted demand anticipated to be advertised in a next 100 or less frames.

4. The method of claim 1, wherein the utilization rates further comprise a respective historical utilization rate of the leftover bandwidth allocations.

5. The method of claim 1, wherein the calculating comprises calculating the utilization rates for traffic priorities, wherein the traffic priorities comprise a real-time type, a continuous type, and a non-critical traffic type.

6. The method of claim 1, wherein the monitoring maintains a record over a number of frames of the leftover bandwidth allocations provided to the terminals and a corresponding utilization by the terminals.

7. The method of claim 1, further comprising adding a boost value to the respective leftover bandwidth allocation to respond to a spike in the respective advertised demand.

8. The method of claim 1, further comprising adding a boost value to the respective leftover bandwidth allocation beyond the respective advertised demand, when one of the terminals is requesting bandwidth for an application comprising an in-network adaptability feature.

9. The method of claim 8, wherein the application comprises at least one of a live video streaming application or a video conferencing application.

10. The method of claim 1, further comprising adapting a leftover allocation threshold based on learning from a pattern of the respective utilization rate.

11. The method of claim 10, wherein the learning is based on at least one of a simulation result or an input threshold configuration.

12. The method of claim 1, wherein the adjusting alters the scale based on a respective anticipated demand for one of the terminals.

13. The method of claim 1, wherein the adjusting does not eliminate the respective leftover bandwidth allocation for one of the terminals when explicitly requested even when the respective advertised demand for one of the terminals is less than a threshold.

14. A system to distribute leftover bandwidth in a satellite communication network, the system comprising:
a bandwidth allocator configured to:
monitor utilization rates of real-time leftover bandwidth allocations for terminals,
calculate, for the terminals, leftover bandwidth allocations based on a respective utilization rate of the utilization rates,
adjust the leftover bandwidth allocations for the terminals with a scale that prioritizes a respective leftover bandwidth allocation for a respective terminal based on a respective advertised demand, and
allocate the leftover bandwidth allocations to the terminals; and
a receiver to receive one or more bursts transmitted from the terminals within one of the leftover bandwidth allocations.

15. The system of claim 14, wherein the adjusting further scales based on an anticipated demand for the respective terminal.

16. The system of claim 14, wherein the bandwidth allocator is further configured to calculate the utilization rates for traffic priorities, wherein the traffic priorities comprise a real-time type, a continuous type, and a non-critical traffic type.

17. The system of claim 14, wherein the bandwidth allocator is further configured to maintain a record over a number of frames of the leftover bandwidth allocations provided to the terminals and a corresponding utilization by the terminals.

18. The system of claim 14, wherein the bandwidth allocator is further configured to add a boost value to the respective leftover bandwidth allocation to respond to a spike in the respective advertised demand.

19. The system of claim 14, wherein the bandwidth allocator is further configured to add a boost value to the respective leftover bandwidth allocation beyond the respective advertised demand, when one of the terminals is requesting bandwidth for an application comprising an in-network adaptability feature.

20. The system of claim 14, wherein the bandwidth allocator is further configured to adapt a leftover allocation threshold based on learning from a pattern of the respective utilization rate.
